(19) United States
(12) Patent Application Publication
(10) Pub. No.: US 2012/0235939 A1
(43) Pub. Date: Sep. 20, 2012

(54) Touch-Panel-Equipped Electronic Device

(75) Inventors: Shinichiro Sakaguchi, Nagaokakyo-Shi (JP); Kazunari Tagata, Nagaokakyo-Shi (JP); Toshio Imanishi, Nagaokakyo-Shi (JP)

(73) Assignee: MURATA MANUFACTURING CO., LTD., Nagaokakyo-Shi (JP)

(21) Appl. No.: 13/468,162

(22) Filed: May 10, 2012

Related U.S. Application Data
(63) Continuation of application No. PCT/JP2010/068176, filed on Oct. 15, 2010.

(30) Foreign Application Priority Data
Nov. 19, 2009 (JP) 2009-264003

(51) Int. Cl. G06F 3/041

(52) U.S. Cl. 345/173

(57) ABSTRACT

A touch-panel-equipped electronic device having a display panel, a touch panel, vibration elements, and vibration propagation members. The touch panel is disposed above the display panel. The vibration elements are disposed lateral to the display panel. The vibration propagation members propagate vibrations of the vibration elements to the touch panel. Each vibration element is disposed such that a vibration direction of a vibration plate thereof is parallel to the normal direction of the display panel.

### CROSS REFERENCE TO RELATED APPLICATIONS

The present application is a continuation of International application No. PCT/JP2010/068176, filed Oct. 15, 2010, which claims priority to Japanese Patent Application No. 2009-264003, filed Nov. 19, 2009, the entire contents of each of which are incorporated herein by reference.

### FIELD OF THE INVENTION

The present invention relates to a touch-panel-equipped electronic device, and specifically, relates to a touch-panel-equipped electronic device which includes a display panel and a touch panel disposed above the display panel.

### BACKGROUND OF THE INVENTION

In recent years, touch-panel-equipped electronic devices such as a portable information terminal and an automated teller machine (ATM) have widely been used. In a touch-panel-equipped electronic device, an operator can perform an input operation by touching a touch panel. However, for example, unlike a button type input device, in the touch-panel-equipped electronic device, a touch panel does not deform during an operation. Thus, in the touch-panel-equipped electronic device, it is difficult to recognize whether an operation has assuredly been performed. Therefore, in an existing touch-panel-equipped electronic device, when a touch panel is operated, a sound is generated or a screen is changed to notify an operator that the operation has been performed.

Further, as another method for notifying an operator that an operation has been performed, there is a method in which a touch panel is vibrated when an operation is completed. According to this method, for example, even when an amount of light is insufficient or noise is loud in the surrounding environment of the touch-panel-equipped electronic device, the operator can assuredly be notified of the completion of the operation. An example of an electronic device in which a touch panel vibrates when an operation is completed is a touch panel display device described in Patent Literature 1 described below.

FIG. 10 is a perspective view of the touch panel display device described in Patent Literature 1 described below. As shown in FIG. 10, the touch panel display device 100 includes a support structure 101 having a fixed wall 101a. A moveable panel unit 103 is disposed on the support structure 101 via elastic bodies 102. In the moveable panel unit 103, a display panel which displays an image and a touch panel are integrally coupled with each other.

A piezoelectric actuator 110 is disposed between the moveable panel unit 103 and the fixed wall 101a. The piezoelectric actuator 110 includes a piezoelectric plate whose normal line is directed in a surface direction x of the moveable panel unit 103. The piezoelectric actuator 110 vibrates in the surface direction x.

In the touch panel display device 100, when an operator touches the moveable panel unit 103 and an input is completed, the piezoelectric actuator 110 is driven and the moveable panel unit 103 vibrates. By this, the operator is notified of the completion of the input.
Patent Literature 1: Japanese Unexamined Patent Application Publication No. 2007-34991

### SUMMARY OF THE INVENTION

Meanwhile, in order to assuredly notify the operator of the completion of the operation, it is necessary to provide sufficiently large vibrations to the moveable panel unit 103. In order to provide sufficiently large vibrations to the moveable panel unit 103, it is necessary to increase output of the piezoelectric actuator 110. In order to increase the output of the piezoelectric actuator 110, it is necessary to increase a width dimension W of the piezoelectric actuator 110 along a height direction H. However, when the width dimension W of the piezoelectric actuator 110 is made larger than the thickness dimension of the moveable panel unit 103, the touch panel display device 100 is increased in size. Thus, in reality, it is difficult to sufficiently increase the width dimension W of the piezoelectric actuator 110. Therefore, it is difficult to provide sufficiently large vibrations to the moveable panel unit 103, and it is difficult to assuredly provide a notice to the operator.

The present invention is made in view of the above point, and its object is to provide a touch-panel-equipped electronic device which can assuredly notify an operator of completion of an input and the like and which has a small thickness dimension.

A touch-panel-equipped electronic device according to the present invention includes a display panel, a touch panel, a vibration element, and a vibration propagation member. The touch panel is disposed above the display panel. The vibration element is disposed lateral to the display panel. The vibration propagation member propagates vibrations of the vibration element to the touch panel. The vibration element is disposed such that a vibration direction of the vibration element is parallel to a normal direction of the display panel.

In a specific aspect of the touch-panel-equipped electronic device according to the present invention, an opening is formed in the vibration propagation member, and the vibration element is fitted directly in the opening of the vibration propagation member. According to this configuration, the thickness dimension of the touch-panel-equipped electronic device can be decreased further.

In another specific aspect of the touch-panel-equipped electronic device according to the present invention, the touch-panel-equipped electronic device further includes a housing accommodating the display panel and the touch panel therein, and the vibration propagation member is supported by the housing via the vibration element, thereby supporting the touch panel by the housing.

In another specific aspect of the touch-panel-equipped electronic device according to the present invention, an opening is formed in the housing, and the vibration element is fitted directly in the opening of the housing. According to this configuration, the thickness dimension of the touch-panel-equipped electronic device can be decreased further.

In still another specific aspect of the touch-panel-equipped electronic device according to the present invention, the vibration element includes a piezoelectric plate made of a piezoelectric substance, and a pair of electrodes through which a voltage is applied to the piezoelectric plate.

In the present invention, the vibration element is disposed such that the vibration direction of the vibration element is parallel to the normal direction of the display panel. Thus, even when the width dimension of the vibration element is increased in order to increase output of the vibration element, the thickness dimension of the vibration element along the normal direction of the display panel does not increase. Therefore, while increase in thickness dimension of the touch-panel-equipped electronic device is suppressed, an operator can assuredly be notified of completion of an input and the like.

### BRIEF DESCRIPTION OF THE DRAWINGS

FIG. 1 is a schematic perspective view of an electronic device according to an embodiment of the present invention.

FIG. 2 is a schematic perspective view of a vibration propagation member.

FIG. 3 is a schematic cross-sectional view of a line III-III portion of FIG. 1.

FIG. 4 is a schematic cross-sectional view of a piezoelectric element.

FIG. 5 is a schematic cross-sectional view of an electronic device according to a first modified example.

FIG. 6 is a schematic perspective view of a vibration propagation member in a second modified example.

FIG. 7 is a schematic cross-sectional view of an electronic device according to a third modified example.

FIG. 8 is a schematic cross-sectional view of an electronic device according to a fourth modified example.

FIG. 9 is a schematic cross-sectional view of an electronic device according to a fifth modified example.

FIG. 10 is a perspective view of an electronic device which is described in Patent Literature 1 and notifies of completion of an operation by vibrations.

### DETAILED DESCRIPTION OF THE PREFERRED EMBODIMENTS

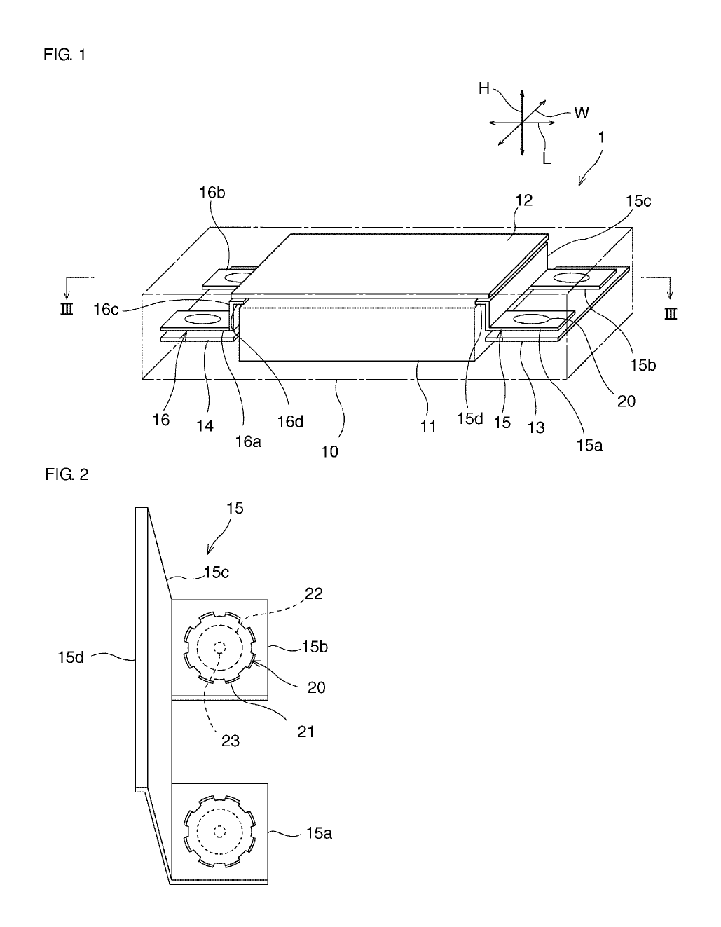

Hereinafter, a preferred embodiment implementing the present invention will be described with a touch-panel-equipped electronic device 1 shown in FIG. 1, as an example. However, the touch-panel-equipped electronic device 1 is merely illustrative. The present invention is not limited to the touch-panel-equipped electronic device 1.

As shown in FIG. 1, the touch-panel-equipped electronic device 1 includes a display panel 11 and a touch panel 12.

The display panel 11 is a mechanism that displays characters and images. Display objects of the display panel 11 are not particularly limited. The display panel 11 may be, for example, one that displays numbers, characters, arrows, a play button, a stop button, and the like. The display panel 11 may be one that displays a display object of a determined pattern, or may be one that displays an appropriate display object in accordance with a situation.

The display panel 11 can be composed of, for example, a liquid crystal display panel, a plasma display panel, an EL (Electro Luminescence) display panel such as an organic EL display panel or an inorganic EL display panel, an LED (Light Emitting Diode) display panel, or the like. The display panel 11 may be a composite of a plurality of display elements.

The touch panel 12 is disposed above the display panel 11. In this embodiment, the touch panel 12 is not in contact with the display panel 11. The touch panel 12 transmits light from the display panel 11 and is a mechanism in order for an operator to input information. Specifically, by the operator touching a specific portion of the touch panel 12, information corresponding to the portion touched by the operator is inputted.

The type of the touch panel 12 is not particularly limited. The touch panel 12 may be, for example, a resistive touch panel or a capacitive touch panel. Alternatively, the touch panel 12 may be, for example, an acoustic wave touch panel, an infrared touch panel, or an electromagnetic induction touch panel.

The touch panel 12 and the display panel 11 are accommodated in a housing 10. The housing 10 is not particularly limited as long as it can retain the touch panel 12 and the display panel 11. The housing 10 may be made of, for example, resin or metal. Specifically, the housing 10 may be made of, for example, an ABS resin, a polycarbonate resin, or the like. Alternatively, the housing 10 may be made of aluminum, iron, an aluminum alloy, an iron alloy such as stainless steel, or the like. In this specification, “being made of metal” includes being made of an alloy.

The display panel 11 is fixed to the housing 10. Meanwhile, the touch panel 12 is not fixed directly to the housing 10. The touch panel 12 is attached to the housing 10 via vibration propagation members 15 and 16 which serves as support members to support the touch panel 12 and serves to propagate vibrations of later-described piezoelectric vibration elements 20 to the touch panel 12. The touch panel may be fixed to the housing via an elastic body.

Specifically, retaining plates 13 and 14 are provided in the housing 10. The retaining plates 13 and 14 are disposed lateral to both short sides of the display panel 11. One-side edge portions 15a, 16a, 15b, and 16b of the vibration propagation members 15 and 16 are attached to the retaining plates 13 and 14 via the later-described piezoelectric vibration elements 20. The edge portions 15a, 16a, 15b, and 16b are connected to other-side edge portions 15d and 16d via connection portions 15c and 16c. Both edge portions of the touch panel 12 on its short sides are supported by the other-side edge portions 15d and 16d. More specifically, the edge portions 15a and 15b are disposed parallel to a principal surface of the touch panel 12. The edge portions 15a and 15b are disposed lateral to the short side of the display panel 11. A one-side edge portion of the connection portion 15c is connected to the edge portions 15a and 15b. The connection portion 15c is disposed lateral to the short side of the display panel 11. The connection portion 15c is formed in a plate shape and faces a side surface of the touch panel 12. The edge portion 15d is connected to an other-side edge portion of the connection portion 15c. The edge portion 15d is connected to an edge portion of the touch panel 12. The connection portion 15c and the edge portions 15a and 15b are preferably formed in an L shape. In this case, even when the piezoelectric vibration element 20 is increased in size, the piezoelectric vibration element 20 can suitably be retained by extending the edge portion 15a in a direction parallel to the principal surface of the touch panel 12 by a length equivalent to the size increase of the piezoelectric vibration element 20. Thus, while increase in thickness dimension of the housing 10 is suppressed, large vibrations can be provided to the operator.

The locations of the retaining plates are not particularly limited. The retaining plates may be disposed lateral to both long sides of the display panel. Alternatively, the retaining plates may be disposed lateral to one side or three sides of the display panel.

The retaining plates 13 and 14 may be formed integral with the housing 10 or may be formed independently of the housing 10. The retaining plates 13 and 14 are preferably ones having high rigidity. Thus, the retaining plates 13 and 14 are preferably made of metal. Therefore, for example, when the housing 10 is made of resin, the retaining plates 13 and 14 are preferably formed independently of the housing 10.

Next, an attached mode and a configuration of each piezoelectric vibration element 20 will be described with reference to FIGS. 1 to 4.

The piezoelectric vibration elements 20 are elements for providing vibrations to the touch panel 12 via the vibration propagation members 15 and 16. In this embodiment, an example where the piezoelectric vibration elements 20 are used as ones for providing vibrations to the touch panel 12 will be described. However, in the present invention, vibration elements are not limited to the piezoelectric vibration elements. The vibration elements may be, for example, electromagnetic actuators using a magnet or coil, or may be actuators using a spring.

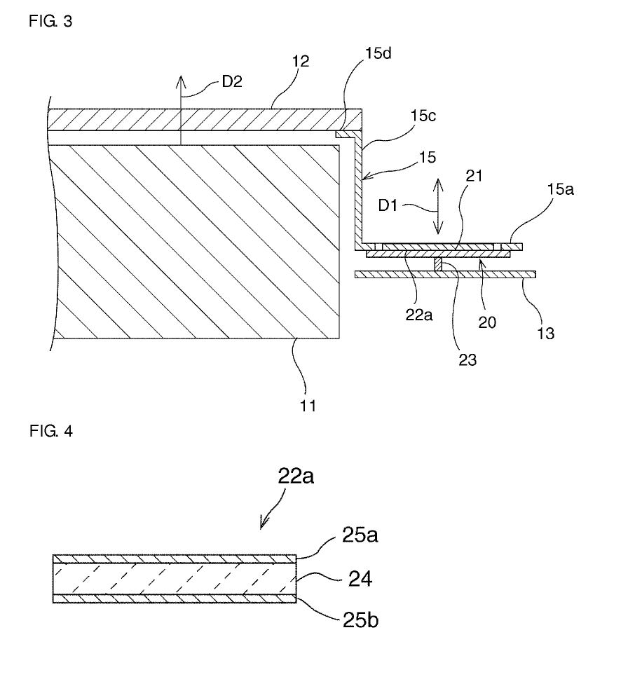

As shown in FIG. 3, each piezoelectric vibration element 20 includes an elastic plate 21 and a piezoelectric element 22a. In this embodiment, each piezoelectric vibration element 20 is a unimorph type piezoelectric vibration element, and the piezoelectric element 22a is provided on one surface of the elastic plate 21. However, in the present invention, each piezoelectric vibration element is not limited to the unimorph type. Each piezoelectric vibration element may be, for example, a bimorph type piezoelectric vibration element in which piezoelectric elements are provided on both surfaces of an elastic plate. Alternatively, each piezoelectric vibration element may be an exciter type piezoelectric vibration element, or may be a laminate type piezoelectric vibration element in which a plurality of piezoelectric elements is laminated. Still alternatively, each piezoelectric vibration element may be one that does not have an elastic plate and is composed of only a piezoelectric element.

In this embodiment, the elastic plate 21 is formed in a substantially circular shape. In addition, the piezoelectric element 22a is similarly formed in a substantially circular shape. However, in the present invention, the shapes of the elastic plate and the piezoelectric element are not particularly limited. Each of the elastic plate and the piezoelectric element may be formed, for example, in a rectangular or polygonal shape. In this specification, the “substantially circular shape” includes a perfect circle.

The elastic plate 21 is not particularly limited as long as it is a plate having elasticity. The elastic plate 21 may be made of, for example, resin such as a glass epoxy resin, or metal. Among them, the elastic plate 21 is preferably made of metal, and is more preferably made of brass, a nickel alloy, or stainless steel.

As shown FIG. 4, the piezoelectric element 22a includes a piezoelectric substrate 24. Electrodes 25a and 25b are formed on both surfaces of the piezoelectric substrate 24. A voltage is applied to the piezoelectric substrate 24 through these electrodes 25a and 25b. As a result, the elastic plate 21 vibrates together with the piezoelectric element 22a.

The piezoelectric substrate 24 is made of a piezoelectric substance. Specific examples of the piezoelectric substance include lead zirconate titanate (PZT). The electrodes 25a and 25b can be formed from, for example, Au, Pt, Ag, Cr, Ni, or an alloy including at least one of these metals.

Next, the attached mode of each piezoelectric vibration element 20 will be described mainly with reference to FIGS. 2 and 3. The vibration propagation member 15 is representatively shown in FIGS. 2 and 3. However, the vibration propagation member 16 also has substantially the same configuration as that of the vibration propagation member 15, and thus the vibration propagation members 15 and 16 will be described simultaneously with reference to FIGS. 2 and 3.

As shown in FIG. 3, a substantially circular opening is formed in each of the edge portions 15a, 16a, 15b, and 16b. The peripheral portion of the elastic plate 21 of each piezoelectric vibration element 20 is fitted in the opening. Specifically, the opening formed in each of the edge portions 15a, 16a, 15b, and 16b is formed in a gear shape in which a plurality of convex portions extending outward in a radial direction and a plurality of concave portions extending inwardly in the radial direction are alternately arranged along a circumferential direction. Then, the elastic plate 21 is fitted to the plurality of concave portions. Thus, gaps are formed between the opening and the elastic plate 21. For that reason, air is allowed to flow between above and below the elastic plate 21. Therefore, vibrations of each piezoelectric vibration element 20 are unlikely to be impaired. As a result, each piezoelectric vibration element 20 can be vibrated with high efficiency.

The shape of the opening formed in each of the edge portions 15a, 16a, 15b, and 16b may not be the gear shape. The shape of the opening is not particularly limited as long as it is a shape which allows the elastic plate to be fitted. The opening may be, for example, a shape with which no gaps are formed between the opening and the elastic plate.

Further, since the piezoelectric vibration element 20 is fitted in the opening, contact between each of the vibration propagation members 15 and 16 and the piezoelectric vibration element 20 can be suppressed. Therefore, drive sound of the touch panel 12 can effectively be reduced.

Further, since the piezoelectric vibration element 20 is fitted in the opening without using a contact pad as in this embodiment, increase in distance between the retaining plates 13 and 14 and the edge portions 15a, 16a, 15b, and 16b can effectively be suppressed.

As shown in FIG. 3, a substantially central portion of a surface of the piezoelectric element 22a which is opposed to a surface thereof on the elastic plate 21 side is in contact with the retaining plate 13 or 14 via a contact pad 23. Thus, when each piezoelectric vibration element 20 is driven, the vibration propagation members 15 and 16 vibrate. As a result, the touch panel 12 also vibrates.

The material of the contact pad 23 is not particularly limited. The contact pad 23 can be formed from hard material, for example, resin such as an ABS resin or a glass cloth base epoxy resin, or metal such as stainless steel. Since the contact pad 23 is formed from the hard material, loss of vibrations of each piezoelectric vibration element 20 can be reduced. The contact pad 23 may be formed integrally with the retaining plate 13 or 14.

As shown in FIGS. 3 and 1, each piezoelectric vibration element 20 is disposed lateral to the display panel 11 such that a vibration direction D1 of the piezoelectric vibration element 20 is parallel to the normal direction D2 of the display panel 11. Here, output of each piezoelectric vibration element 20 correlates with the area of the piezoelectric element 22a of the piezoelectric vibration element 20. Specifically, by increasing the area of the piezoelectric element 22a, the output of the piezoelectric vibration element 20 can be increased. Therefore, in this embodiment in which each piezoelectric vibration element 20 is disposed lateral to the display panel 11 such that the vibration direction D1 of the piezoelectric vibration element 20 is parallel to the normal direction D2 of the display panel 11, the output of each piezoelectric vibration element 20 can be increased without increasing the thickness along the vibration direction D1 of the piezoelectric vibration element 20. Therefore, while the thickness of the piezoelectric vibration element 20 is made equal to or less than the thickness of the display panel 11, the output thereof can be increased. As a result, while increase in thickness dimension of the touch-panel-equipped electronic device 1 is suppressed, the operator can assuredly be notified of completion of an input and the like.

Further, in this embodiment, since each piezoelectric vibration element 20 is disposed lateral to the display panel 11 such that the vibration direction D1 of the piezoelectric vibration element 20 is parallel to the normal direction D2 of the display panel 11, a plurality of the piezoelectric vibration elements 20 can be disposed. In addition, flexibility in the shape and dimension of each piezoelectric vibration element 20 is high. Moreover, by changing the shapes of the vibration propagation members 15 and 16, the location of each piezoelectric vibration element 20 can freely be changed.

Hereinafter, modified examples of this embodiment will be described. In the description of the following modified examples, components having functions substantially common with those of the first embodiment are designated by the common signs, and the description thereof is omitted.

### First Modified Example

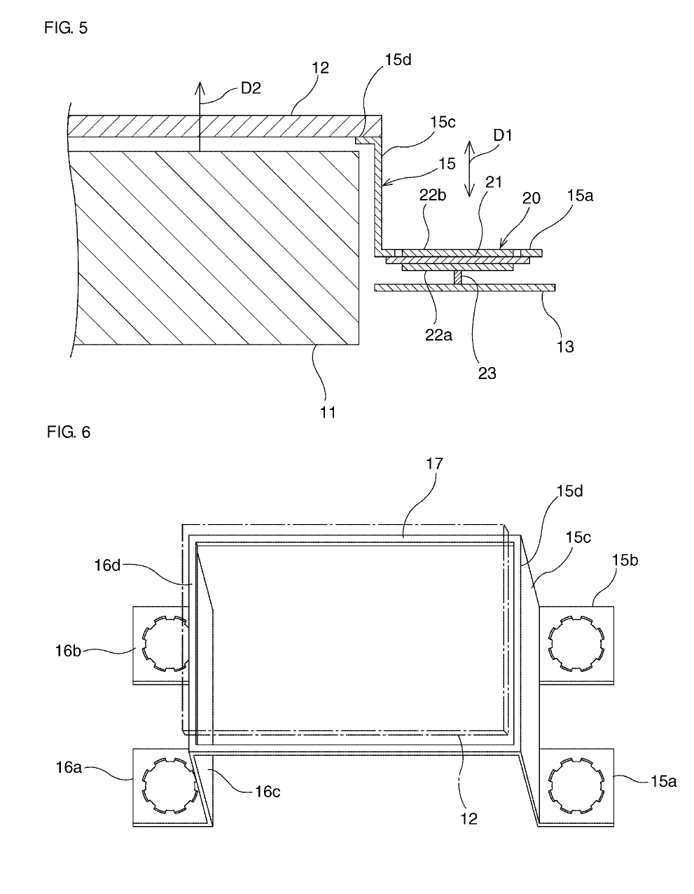

In the first embodiment described above, the example where each piezoelectric vibration element 20 is the unimorph type has been described. However, the present invention is not limited to this configuration. As shown in FIG. 5, each piezoelectric vibration element 20 may be, for example, a bimorph type. In other words, each piezoelectric vibration element 20 may be one in which a piezoelectric element 22b is provided on a side of the elastic plate 21 which is opposed to the side thereof on which the piezoelectric element 22a is provided.

### Second Modified Example

In the first embodiment described above, the example where the vibration propagation members 15 and 16 are provided as separate members has been described. However, the present invention is not limited to this configuration. For example, as shown in FIG. 6, the vibration propagation member 15 and the vibration propagation member 16 may be connected and integrated with each other via a bridge portion 17.

### Third and Fourth Modified Examples

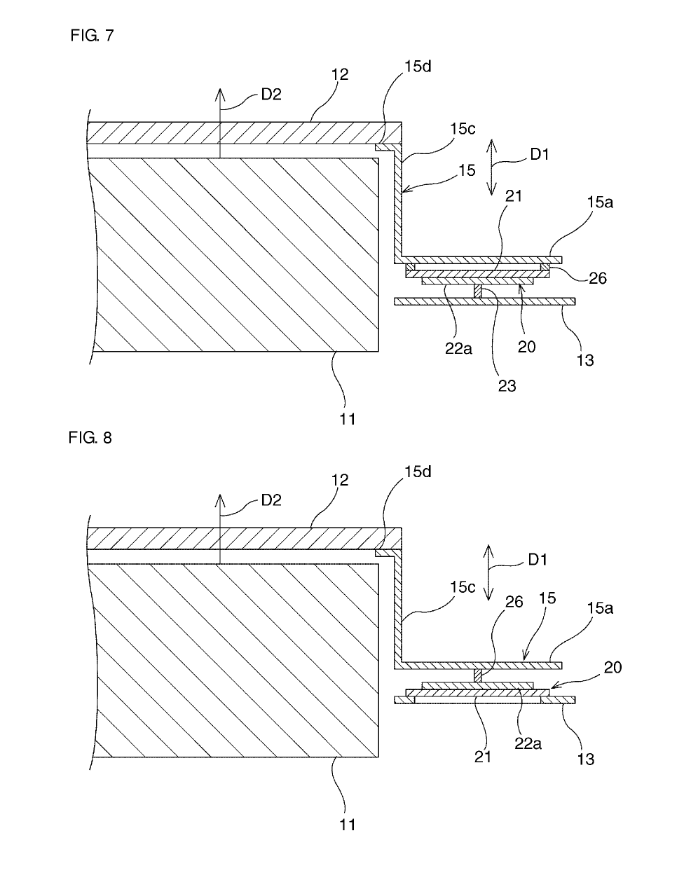

In the first embodiment described above, the example where the piezoelectric vibration elements 20 are fitted in the openings formed in the vibration propagation members 15 and 16 has been described. However, the present invention is not limited to this configuration. For example, as shown representatively in FIG. 7, no openings may be formed in the edge portions 15a, 16a, 15b, and 16b of the vibration propagation members 15 and 16, and each of the edge portions 15a, 16a, 15b, and 16b of the vibration propagation members 15 and 16 and the piezoelectric vibration element 20 may be connected to each other via a contact pad 26. Alternatively, as shown in FIG. 8, openings may be formed in the retaining plates 13 and 14, and the piezoelectric vibration element 20 may be fitted directly in each of the openings of the retaining plates 13 and 14.

### Fifth Modified Example

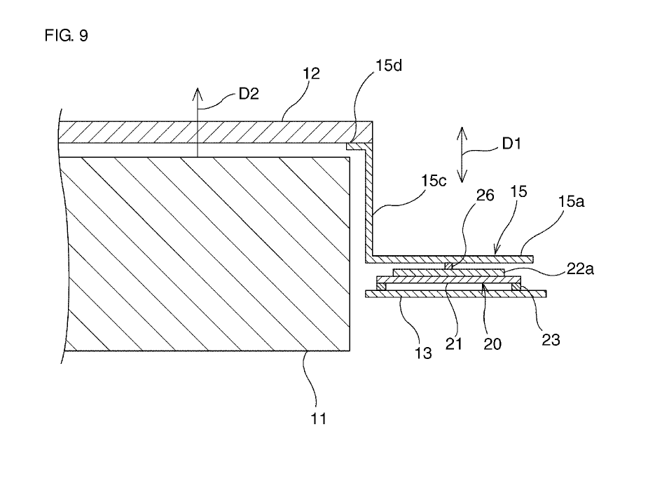

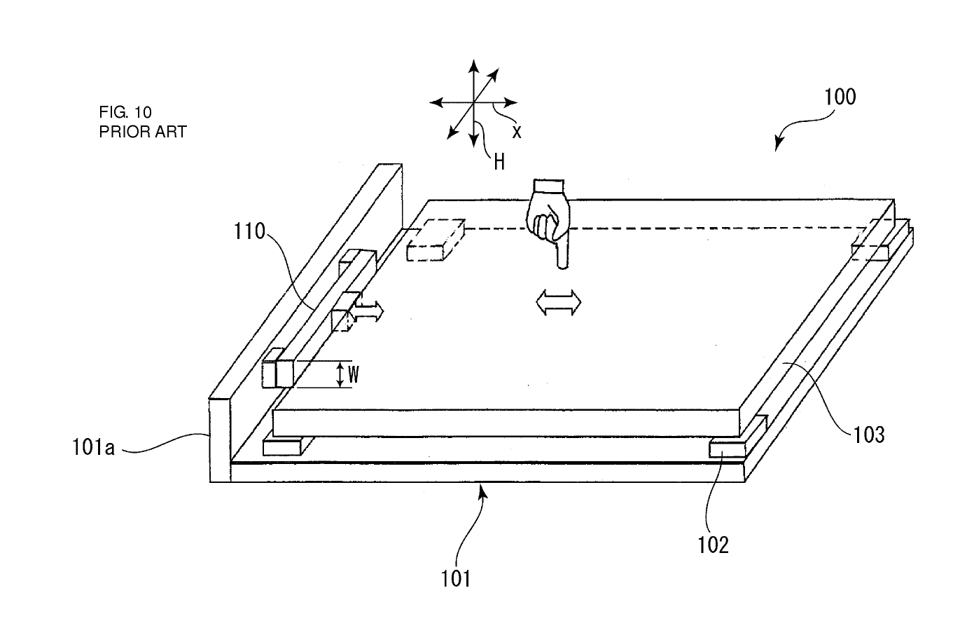

In the first embodiment described above, the example where each piezoelectric vibration element 20 is disposed such that the piezoelectric element 22a side of the piezoelectric vibration element 20 faces the retaining plate 13 or 14 side has been described. However, the present invention is not limited to this configuration. As shown in FIG. 9, each piezoelectric vibration element 20 may be disposed such that the piezoelectric element 22a side of the piezoelectric vibration element 20 faces the vibration propagation member 15 or 16 side.

### REFERENCE SIGNS LIST

1 touch-panel-equipped electronic device
10 housing
11 display panel
12 touch panel
13, 14 retaining plate
15, 16 vibration propagation member
15a, 16a, 15b, 16b one-side edge portion of vibration propagation member
15c, 16c connection portion
15d, 16d other-side edge portion of vibration propagation member
17 bridge portion
20 piezoelectric vibration element
21 elastic plate
22a, 22b piezoelectric element
23, 26 contact pad
24 piezoelectric substrate
25a, 25b electrode

1. A touch-panel-equipped electronic device comprising:
a display panel;
a touch panel disposed above the display panel;
a vibration element disposed lateral to the display panel and oriented such that a vibration direction of the vibration element is parallel to a normal direction of the display panel; and
a vibration propagation member configured to propagate vibrations of the vibration element to the touch panel.

2. The touch-panel-equipped electronic device according to claim 1, wherein the vibration propagation member defines an opening within which the vibration element is fitted.

3. The touch-panel-equipped electronic device according to claim 1, wherein the vibration propagation member supports the touch panel such that the touch panel does not directly contact the display panel.

4. The touch-panel-equipped electronic device according to claim 1, further comprising a housing accommodating the display panel and the touch panel therein, wherein
the vibration propagation member is supported by the housing via the vibration element.

5. The touch-panel-equipped electronic device according to claim 4, wherein the housing includes an opening within which the vibration element is fitted.

6. The touch-panel-equipped electronic device according to claim 1, further comprising:
a housing accommodating the display panel and the touch panel therein; and
a retaining plate attached to the housing, the retaining plate supporting the vibration propagation member.

7. The touch-panel-equipped electronic device according to claim 6, wherein the retaining plate includes an opening within which the vibration element is fitted.

8. The touch-panel-equipped electronic device according to claim 1, wherein the vibration element includes: a piezoelectric plate made of a piezoelectric substance; and a pair of electrodes through which a voltage is applied to the piezoelectric plate.

9. The touch-panel-equipped electronic device according to claim 1, wherein the vibration element is a unimorph type vibration element.

10. The touch-panel-equipped electronic device according to claim 1, wherein the vibration element is a bimorph type vibration element.

11. The touch-panel-equipped electronic device according to claim 1, wherein the vibration propagation member is a first vibration propagation member, the touch-panel-equipped electronic device further comprising a second vibration propagation member arranged on a side of the touch panel opposite to that of the first vibration propagation member.

12. The touch-panel-equipped electronic device according to claim 11, wherein the first and second vibration propagation members are connected to each other by a bridge portion.

13. A vibration propagation member for use with a touch-panel-equipped electronic device, the vibration propagation member comprising:
a support portion configured to support at least an edge of a touch panel above a display panel;
a vibration element portion positioned so as to extend on a lateral side of the display panel and oriented such that a vibration direction of a vibration element in contact with the vibration element portion is parallel to a normal direction of the display panel; and
a connecting portion connecting the support portion and the vibration element portion.

14. The vibration propagation member according to claim 13, wherein the vibration element portion defines an opening within which the vibration element is fitted.

15. The vibration propagation member according to claim 13, wherein the support portion supports the touch panel such that the touch panel does not directly contact the display panel.

16. The vibration propagation member according to claim 13, wherein the support portion is a first support portion, the vibration element portion is a first vibration element portion, and the connecting portion is a first connecting portion, the vibration propagation member further comprising:
a second support portion arranged on a side of the touch panel opposite to that of the first support portion, the second support portion configured to support the touch panel above the display panel;
a second vibration element portion positioned so as to extend on a lateral side of the display panel opposite to that of the first vibration element, the second vibration element being oriented such that a second vibration direction of a second vibration element in contact with the second vibration element portion is parallel to the normal direction of the display panel;
a second connecting portion connecting the second support portion and the second vibration element portion; and
a bridge portion connecting the first and second support portions.
